(19) United States
(12) Patent Application Publication
(10) Pub. No.: US 2018/0023491 A1
(43) Pub. Date: Jan. 25, 2018

(54) AIR CONTROL VALVE FOR TRANSPORTATION REFRIGERATION SYSTEM

(71) Applicant: Carrier Corporation, Farmington, CT (US)

(72) Inventors: Garrison S. MOSELEY, Liverpool, NY (US); Benjamin Edward FERGUSON, Cazenovia, NY (US); John T. STEELE, Marcellus, NY (US)

(21) Appl. No.: 15/549,813

(22) PCT Filed: Feb. 22, 2016
(86) PCT No.: PCT/US2016/018884

§ 371 Date: Aug. 9, 2017

Related U.S. Application Data
(60) Provisional application No. 62/120,468, filed on Feb. 25, 2015.

(51) Int. Cl. F02D 41/02; F01N 3/025; F01N 9/00; B60H 1/00

(52) U.S. Cl. CPC F02D 41/029; B60H 1/0045; B60H 1/00378; F01N 3/0253; F01N 9/002; F02D 41/0245; F02D 41/027

(57) ABSTRACT

A transport refrigeration system is provided including a refrigeration unit and a diesel engine powering the refrigeration unit. The diesel engine has an exhaust system for discharging engine exhaust from the diesel engine. An exhaust treatment unit is disposed in the diesel engine exhaust system and includes a diesel oxidation catalyst. An air control valve is configured to control a quantity of air provided to the diesel engine from an air supply fluidly coupled to the diesel engine. A controller is operably coupled to the air control valve and is configured to automatically operate the air control valve to initiate a cleaning cycle of the diesel oxidation catalyst upon detection of a predetermined condition.

### BACKGROUND

The subject matter disclosed herein relates to transportation refrigeration systems. More specifically, the subject matter disclosed herein relates to filtering of exhaust gas from transportation refrigeration systems.

Fruits, vegetables and other perishable items, including meat, poultry and fish, fresh or frozen, are commonly transported in the cargo box of a truck or trailer, or in an intermodal container. Accordingly, it is customary to provide a transportation refrigeration system in operative association with the cargo box for cooling the atmosphere within the cargo box. The transport refrigeration system includes a refrigerant vapor compression system, also referred to as a transport refrigeration unit, and an on-board power unit. The refrigerant vapor compression system typically includes a compressor, a condenser, an expansion device and an evaporator serially connected by refrigerant lines in a closed refrigerant circuit in accord with known refrigerant vapor compression cycles. The power unit includes an engine, typically diesel powered.

The diesel engine, however, produces harmful soot particles that are removed from the exhaust stream via a diesel particulate filter (DPF). The filter is periodically regenerated, removing the accumulated soot particles from the filter, either via passive or active means. Passive means using the diesel engine exhaust temperature with a catalyst added to the exhaust stream to raise the exhaust gas temperature to combust the soot particles. Active means using the passive system with the addition of injecting added fuel into the exhaust stream, where the added fuel is oxidized by the catalyst to raise the exhaust gas temperature to combust the soot particles.

Transportation refrigeration systems often operate at low speeds and low loads, which results in exhaust temperature below the catalyst activation temperature, the point at which the catalyst will oxidize hydro carbons. During such conditions, the DPF will not successfully passively or actively regenerate.

### BRIEF SUMMARY

According to one embodiment, a transport refrigeration system is provided including a refrigeration unit and a diesel engine powering the refrigeration unit. The diesel engine has an exhaust system for discharging engine exhaust from the diesel engine. An exhaust treatment unit is disposed in the diesel engine exhaust system and includes a diesel oxidation catalyst. An air control valve is configured to control a quantity of air provided to the diesel engine from an air supply fluidly coupled to the diesel engine. A controller is operably coupled to the air control valve and is configured to automatically operate the air control valve to initiate a cleaning cycle of the diesel oxidation catalyst upon detection of a predetermined condition.

In addition to one or more of the features described above, or as an alternative, in further embodiments the controller is operably coupled to a timer, the timer being configured to initiate the cleaning cycle at a predetermined interval.

In addition to one or more of the features described above, or as an alternative, in further embodiments the timer is configured to end the cleaning cycle after a predetermined period of time.

In addition to one or more of the features described above, or as an alternative, in further embodiments the exhaust treatment unit includes a first sensor for monitoring a condition of a portion of the exhaust treatment unit upstream from the diesel oxidation catalyst and a second sensor for monitoring a condition of a portion of the exhaust treatment unit downstream from the diesel oxidation catalyst.

In addition to one or more of the features described above, or as an alternative, in further embodiments the first sensor and the second sensor are configured to monitor a temperature of an exhaust gas within the exhaust treatment unit.

In addition to one or more of the features described above, or as an alternative, in further embodiments detection of the predetermined condition includes measuring a difference in the temperature at the first sensor and the second sensor.

In addition to one or more of the features described above, or as an alternative, in further embodiments the predetermined condition is met when the temperature measured by the second sensor exceeds the temperature measured by first sensor for a set period of time.

In addition to one or more of the features described above, or as an alternative, in further embodiments upon detection of the predetermined condition, the controller is configured to determine a position of the air control valve and operate the air control valve to that position.

In addition to one or more of the features described above, or as an alternative, in further embodiments operation of the valve comprises moving the valve towards a closed position to decrease the quantity of air provided to the diesel engine.

According to another embodiment of the invention, a method of automatically determining when to clean a diesel oxidation catalyst of a transport refrigeration system is provided including monitoring a first parameter of an exhaust gas within an exhaust gas pathway downstream from a diesel engine and upstream from the diesel oxidation catalyst. A second parameter of an exhaust gas within the exhaust gas pathway, downstream from the diesel oxidation catalyst is also monitored. Whether the difference between the first parameter and the second parameter exceeds a predetermined threshold is determined, and if so, a cleaning cycle of the diesel oxidation catalyst is initiated.

In addition to one or more of the features described above, or as an alternative, in further embodiments the first parameter and the second parameter are a temperature within the exhaust gas pathway.

In addition to one or more of the features described above, or as an alternative, in further embodiments the monitoring of the first parameter and the second parameter is performed by at least one sensor operably coupled to a controller.

In addition to one or more of the features described above, or as an alternative, in further embodiments initiating a cleaning cycle of the diesel oxidation catalyst further includes determining a position of an air control valve to achieve an exhaust gas of a desired temperature. The air control valve is configured to control a volume of air input to the diesel engine. The air control valve is then moved to the determined position.

In addition to one or more of the features described above, or as an alternative, in further embodiments the exhaust gas of a desired temperature is greater than or equal to the activation temperature of the diesel oxidation catalyst.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of an embodiment of a transport refrigeration system;

FIG. 2 is a schematic view of another embodiment of a transport refrigeration system; and

FIG. 3 is a schematic view of a portion of a transport refrigeration system.

The detailed description explains embodiments of the invention, together with advantages and features, by way of example with reference to the drawing.

### DETAILED DESCRIPTION

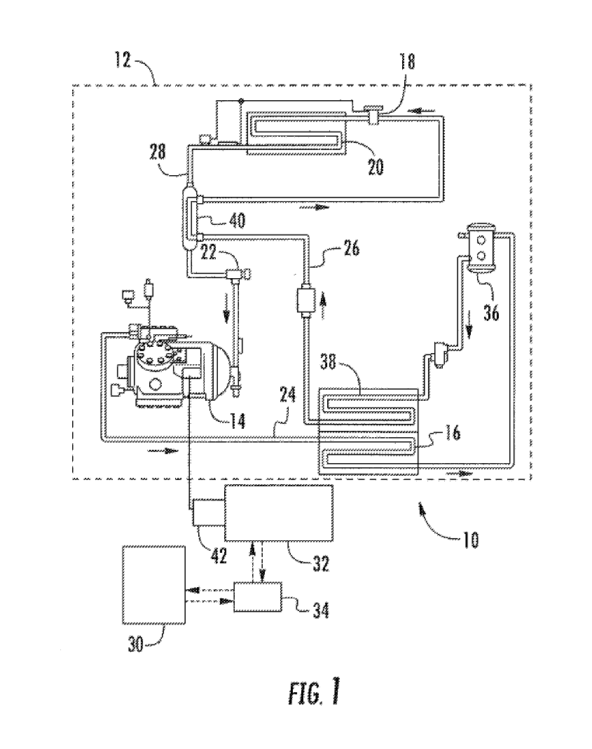

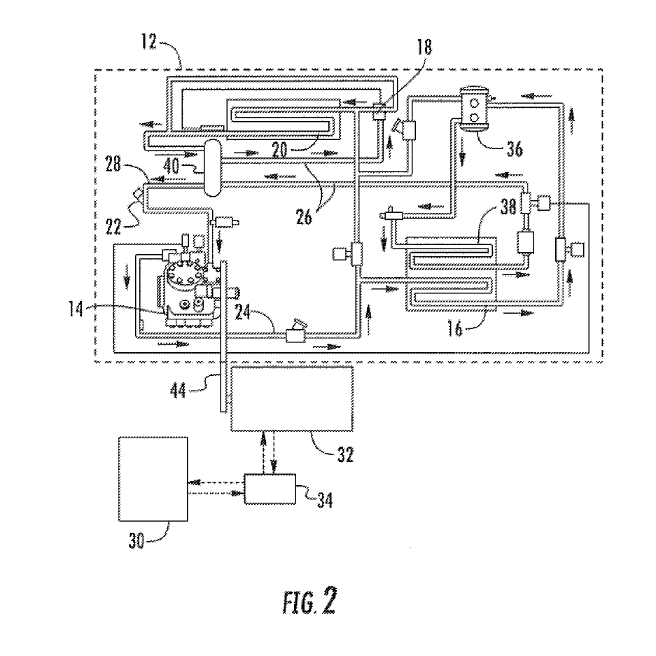

Referring initially to FIGS. 1 and 2, there are depicted exemplary embodiments of transport refrigeration systems for controlling the temperature of the atmosphere within the cargo box of a truck, trailer, container, intermodal container or similar cargo transportation unit. The transportation refrigeration system 10 includes a transport refrigeration unit 12 including a compressor 14, a refrigerant condenser heat exchanger 16, an expansion device 18, a refrigerant evaporator heat exchanger 20 and a suction modulation valve 22 connected in a closed loop refrigeration circuit including refrigerant lines 24, 26 and 28 and arranged in a conventional refrigeration cycle. The transport refrigeration system 10 further includes an electronic system controller 30, a diesel engine 32 and an engine controller 34. The transport refrigeration system 10 is mounted as in conventional practice to an exterior wall of the truck, trailer or container with the compressor 14 and the condenser heat exchanger 16 with its associated condenser fan(s) (not shown) and diesel engine 32 disposed externally of the refrigerated cargo box.

As is conventional practice, when the transport refrigeration unit 12 is operating in a cooling mode, low temperature, low pressure refrigerant vapor is compressed by the compressor 14 to a high pressure, high temperature refrigerant vapor and passed from the discharge outlet of the compressor 14 into refrigerant line 24. The refrigerant circulates through the refrigerant circuit via refrigerant line 24 to and through the heat exchange tube coil or tube bank of the condenser heat exchanger 16, wherein the refrigerant vapor condenses to a liquid, thence through the receiver 36, which provides storage for excess liquid refrigerant, and thence through the subcooler coil 38 of the condenser. The subcooled liquid refrigerant then passes through refrigerant line 24 through a first refrigerant pass of the refrigerant-to-refrigerant heat exchanger 40, and thence traverses the expansion device 18 before passing through the evaporator heat exchanger 20. In traversing the expansion device 18, which may be an electronic expansion valve (EXV) as depicted in FIG. 1 or a mechanical thermostatic expansion valve (TXV) as depicted in FIG. 2, the liquid refrigerant is expanded to a lower temperature and lower pressure prior to passing to the evaporator heat exchanger 20.

In flowing through the heat exchange tube coil or tube bank of the evaporator heat exchanger 20, the refrigerant evaporates, and is typically superheated, as it passes in heat exchange relationship return air drawn from the cargo box passing through the airside pass of the evaporator heat exchanger 20. The refrigerant vapor thence passes through the refrigerant line 26, the refrigerant vapor traverses a second refrigerant pass of the refrigerant-to refrigerant heat exchanger 40 in heat exchange relationship with the liquid refrigerant passing through the first refrigerant pass thereof. Before entering the suction inlet of the compressor 14, the refrigerant vapor passes through the suction modulation valve 22 disposed in refrigerant line 26 downstream with respect to refrigerant flow of the refrigerant-to-refrigerant heat exchanger 40 and upstream with respect to refrigerant flow of the compressor 14. By selectively reducing the open flow area through the suction modulation valve 22, the controller 30 can selectively restrict the flow of refrigerant vapor supplied to the compressor 14, thereby reducing the capacity output of the transportation refrigeration unit 12 and in turn reducing the power demand imposed on the engine 32.

Air drawn from within the cargo box by the evaporator fan(s) (not shown) associated with the evaporator heat exchanger 20, is passed over the external heat transfer surface of the heat exchange tube coil or tube bank of the evaporator heat exchanger 20 and circulated back into the interior space of the cargo box. The air drawn from the cargo box is referred to as “return air” and the air circulated back into the cargo box is referred to as “supply air”. It is to be understood that the term “air” as used herein includes mixtures of air and other gases, such as for example, but not limited to nitrogen or carbon dioxide, sometimes introduced into a refrigerated cargo box for transport of perishable product such as produce.

Although the particular type of evaporator heat exchanger 20 used is not limiting of the invention, the evaporator heat exchanger 20 may, for example, comprise one or more heat exchange tube coils, as depicted in the drawing, or one or more tube banks formed of a plurality of tubes extending between respective inlet and outlet manifolds. The tubes may be round tubes or flat tubes and may be finned or un-finned.

The compressor 14 may comprise a single-stage or multiple-stage compressor such as, for example, a reciprocating compressor as depicted in the exemplary embodiments shown in FIGS. 1 and 2. However, the compressor 14 may be a scroll compressor or other type of compressor as the particular type of compressor used is not germane to or limiting of the invention. In the exemplary embodiment of FIG. 1, the compressor 14 comprises a reciprocating compressor having a compressing mechanism, an internal electric compressor motor and an interconnecting drive shaft that are all sealed within a common housing of the compressor 14. The diesel engine 32 drives an electric generator 42 that generates electrical power for driving the compressor motor, which in turn drives the compression mechanism of the compressor 14. The drive shaft of the diesel engine 32 drives the generator shaft. In the embodiment of FIG. 2, the compressor 14 is a reciprocating compressor having a compressing mechanism with a shaft driven directly by the drive shaft of the diesel engine 32, either through a direct mechanical coupling or through a belt drive 44 as illustrated in FIG. 2.

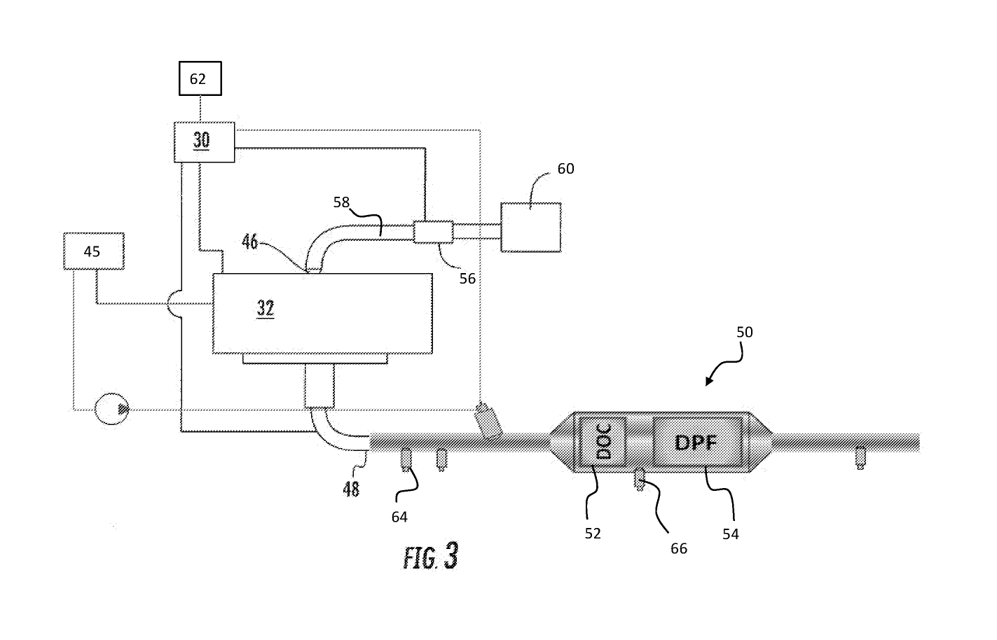

Referring now to FIG. 3, the diesel engine 32 receives diesel fuel from a fuel supply 45 and air through an air inlet 46. After combustion in the diesel engine 32, the byproducts of combustion, exhaust gas including particulates such as soot and other materials, exits the diesel engine 32 via an exhaust system including an exhaust pipe defining an exhaust pathway 48, and an exhaust treatment unit 50 disposed in-line in the exhaust pipe. The exhaust treatment unit 50, such as a catalytic converter for example, includes a diesel oxidation catalyst (DOC) 52 and a diesel particulate filter (DPF) 54 provided along the exhaust pathway 48. The DOC 52 is configured to break down the exhaust pollutants into less harmful substances, such as carbon dioxide and water for example, and the DPF 54 is configured to remove the particulates from the exhaust gas prior to the exhaust gas reaching the ambient atmosphere.

Periodic cleaning of the DOC 52 is performed to remove accumulated soot and organic particles from the upstream surface (not shown) of the DOC 52. Cleaning of the DOC is accomplished using an elevated temperature of the exhaust gas to burn the particles, thus removing the particulates from the surface of the DOC 52. To burn the particles, it is necessary for the exhaust gas to be at a temperature of at least 290° C. It should be understood that the temperatures included herein are intended as examples, and that the activation temperature for cleaning the DOC 52 depends on multiple factors, including, but not limited to a concentration of precious metals within the DOC for example.

To ensure that the exhaust gas is at the necessary temperature, especially when the diesel engine 32 is operating at low speeds and/or low loads, an air control valve 56 is located in an air intake pathway 58 upstream of the air inlet 46 of the diesel engine 32. In some embodiments, the air control valve 56 is located between an engine air cleaner 60 and the air inlet 46, and may be, for example, an electronic or mechanically operated valve. The air control valve 56 is connected to the system controller 30, which may use information, such as diesel engine 32 speed, system load, and/or exhaust gas temperature for example, to control the position of the air control valve 56 and the amount of air flowing there through and into the air inlet 46.

In operation, when the air control valve 56 is moved toward a closed position, the exhaust gas temperature output from each cylinder of the diesel engine 32 and entering the catalytic converter increases. When cleaning of the DOC is desired or required, the controller 30 determines the position of the air control valve 56 required for the exhaust gas to meet or exceed the selected cleaning temperature, and adjusts the air control valve 56 accordingly. The air control valve 56 is positioned such that the selected temperature is reached, but airflow into the air inlet 46 is not overly restricted resulting in engine stall.

The controller 30 may be configured to initiate cleaning of the DOC 52 automatically. In one embodiment, the controller 30 initiates a cleaning cycle at a predetermined interval of time, such as every hour for example, as monitored by a timing mechanism 62 operably coupled thereto. Once a cleaning cycle of the DOC 52 is initiated, the position of the air control valve 56 is selected to drastically reduce the volume of air provided to the diesel engine 32, thereby achieving an exhaust gas having a desired temperature. The air control valve 56 may be held in that position for a predetermined period of time, such as monitored by the timing mechanism 62 for example. The timing mechanism 62 may be arranged external to or may be integrally formed with the controller 30.

Alternatively, or in addition, a plurality of sensors may be arranged downstream from the diesel engine 32, within the exhaust pathway 48. As shown in FIG. 3, a first temperature sensor 64 is located generally downstream from the diesel engine 32 and upstream from the exhaust treatment unit 50. Similarly, a second temperature sensor 66 is arranged downstream from the DOC 52. The second temperature sensor 66 may be arranged within the exhaust treatment unit 50, such as between the DOC 52 and the DPF 54. Each of the temperature sensors 64, 66 is configured to periodically or continuously monitor a temperature of the exhaust gas at various positions within the exhaust pathway 48.

In one embodiment, the controller 30 is configured to monitor the temperature of the exhaust gas within pathway 48 upstream and downstream of the DOC 52 via the plurality of sensors 64, 66 to determine when to clean the soot from the DOC 52 of the exhaust treatment unit 50. If the difference in temperature measured between the first sensor 64 and the second sensor 66 meets a predetermined condition stored within the controller 30, the controller 30 is configured to initiate cleaning of the DOC 52. For example, as soot and other particulates collect on the DOC 52, the temperature of the exhaust gas downstream from the DOC 52, as measured by sensor 66, approaches and may eventually exceed the temperature of the upstream exhaust gas measured by sensor 64. When the downstream temperature of the exhaust gas exceeds the upstream temperature of the exhaust gas for a set period of time, the predetermined condition is be satisfied and the cleaning cycle is initiated.

Upon detection of the predetermined condition, the controller 30 determines a desired position of the air control valve 56 and adjusts the position of the air control valve 56 to drastically reduce the volume of air provided to the diesel engine 32 to achieve an exhaust gas having a desired temperature. As the exhaust gas flows through the DOC 52, the soot accumulated thereon is at least partially incinerated and may be swept away by the fluid flow there through. The controller 30 may be configured to maintain the position of the air control valve 56 to achieve the increased exhaust gas temperature until a second predetermined condition stored within the controller 30 is achieved indicating that the surface of the DOC 52 is clean. In one embodiment, the second predetermined condition is satisfied when the temperature of the exhaust gas measured at sensor 66 is equal to or less than the temperature of the exhaust gas measured at sensor 64.

The use of the air control valve 56 along with controller 30 to adjust the exhaust gas temperature for cleaning of the DOC 52 allows for active regeneration at low loads of the diesel engine 32 utilizing the exhaust gas.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A transport refrigeration system comprising:
a refrigeration unit;
a diesel engine powering the refrigeration unit, the diesel engine having an exhaust system for discharging engine exhaust from the diesel engine;
an exhaust treatment unit disposed in the diesel engine exhaust system, the exhaust treatment unit including a diesel oxidation catalyst;
an air control valve configured to control a quantity of air provided to the diesel engine from an air supply fluidly coupled to the diesel engine; and
a controller operably coupled to the air control valve, the controller being configured to automatically operate the air control valve to initiate a cleaning cycle of the diesel oxidation catalyst upon detection of a predetermined condition.

2. The system according to claim 1, wherein the controller is operably coupled to a timer, the timer being configured to initiate the cleaning cycle at a predetermined interval.

3. The system according to claim 2, wherein the timer is configured to end the cleaning cycle after a predetermined period of time.

4. The system according to claim 1, wherein the exhaust treatment unit includes a first sensor for monitoring a condition of a portion of the exhaust treatment unit upstream from the diesel oxidation catalyst and a second sensor for monitoring a condition of a portion of the exhaust treatment unit downstream from the diesel oxidation catalyst.

5. The system according to claim 4, wherein the first sensor and the second sensor are configured to monitor a temperature of an exhaust gas within the exhaust treatment unit.

6. The system according to claim 5, wherein detection of the predetermined condition includes measuring a difference in the temperature at the first sensor and the second sensor.

7. The system according to claim 5, wherein the predetermined condition is met when the temperature measured by the second sensor exceeds the temperature measured by first sensor for a set period of time.

8. The system according to claim 1, wherein upon detection of the predetermined condition, the controller is configured to determine a position of the air control valve and operate the air control valve to that position.

9. The system according to claim 7, wherein operation of the valve comprises moving the valve towards a closed position to decrease the quantity of air provided to the diesel engine.

10. A method of automatically determining when to clean a diesel oxidation catalyst of a transport refrigeration system, comprising
monitoring a first parameter of an exhaust gas within an exhaust gas pathway downstream from a diesel engine and upstream from the diesel oxidation catalyst;
monitoring a second parameter of an exhaust gas within an exhaust gas pathway downstream from the diesel oxidation catalyst;
determining if a difference in the first parameter and the second parameter exceeds a predetermined threshold; and
initiating a cleaning cycle of the diesel oxidation catalyst.

11. The method according to claim 10, wherein the first parameter and the second parameter are a temperature within the exhaust gas pathway.

12. The method according to claim 10, wherein the monitoring of the first parameter and the second parameter is performed by at least one sensor operably coupled to a controller.

13. The method according to claim 10, wherein initiating a cleaning cycle of the diesel oxidation catalyst further includes:
determining a position of an air control valve to achieve an exhaust gas of a desired temperature, the air control valve configured to control a volume of air input to the diesel engine; and
moving the air control valve to the position.

14. The method of claim 13, wherein the exhaust gas of a desired temperature is greater than or equal to the activation temperature of the diesel oxidation catalyst.
